(19) United States
(12) Patent Application Publication
(10) Pub. No.: US 2013/0183435 A1
(43) Pub. Date: Jul. 18, 2013

(54) LOW TEMPERATURE PLASMA COATING FOR ANTI-BIOFILM FORMATION

(71) Applicants: Hongmin Sun, Columbia, MO (US); Meng Chen, Columbia, MO (US)

(72) Inventors: Hongmin Sun, Columbia, MO (US); Meng Chen, Columbia, MO (US)

(21) Appl. No.: 13/741,216

(22) Filed: Jan. 14, 2013

Related U.S. Application Data
(60) Provisional application No. 61/631,892, filed on Jan. 13, 2012.

(51) Int. Cl. B05D 1/00

(52) U.S. Cl. CPC B05D 1/62
USPC 427/2.25; 427/569; 427/578; 427/2.26; 427/2.3

(57) ABSTRACT

The present invention is a process for surface treatment of a fluid-contacting device where a continuous organo-silicon or organo-silicon and oxygen plasma coating is applied at a low temperature by a plasma deposition technique to at least one contacting surface of the device and devices with the process applied. The plasma coating inhibits bacterial attachment to the device and prevents biofilm formation on said device. The coating preferably has a thickness from about 1 nm to about 100 nm, more preferably from about 20 nm to about 30 nm. The trimethylsilane and oxygen gas mixture is an approximate ratio of 1 to 4. The invention demonstrates that bacterial cells on the organo-silicon or organo-silicon/O₂ coated surface are more susceptible to antibiotic treatment than their counterparts in biofilm formed on uncoated surface.

### CROSS-REFERENCE TO RELATED APPLICATIONS

The application for patent claims priority to U.S. Provisional Application Ser. No. 61/631,892, filed Jan. 13, 2012 and is entitled “Low Temperature Plasma Coating for Anti-Biofilm Formation,” which is hereby incorporated by reference herein to the extent permitted by law.

### GRANT STATEMENT

This invention was made with Government support under Grant No. P01HL57346 and Grant No. 1R44HL097485-01A2 awarded by the National Institute of Health (NIH). The Government has certain rights in the invention.

### FIELD OF INVENTION

The present invention relates to applications of low temperature plasma coatings for implantable medical and other devices with enhanced inhibition against biofilm formation, more specifically, to applications of organo-silicon low temperature plasma coatings on implantable medical devices to prevent biofilm formation and reduce the risk of nosocomial infections.

### BACKGROUND OF INVENTION

Bacteria can develop biofilm on a submerged surface. One common place for biofilm formation is on or within indwelling medical devices such as catheters, respirators, and artificial cardiovascular implants, prosthetic joints, and contact lenses, which pose a critical problem for medical care. Approximately 1 million nosocomial infections are associated with indwelling devices annually in the United States, which incurs enormous healthcare cost.

Biofilm formation on implantable medical devices is a major impediment to the treatment of nosocomial infections, and promotes local progressive tissue destruction. In particular, Staphylococcus epidermidis (S. epidermidis) infections are the leading cause of biofilm formation on indwelling devices. Bacteria in biofilms are highly resistant to antibiotic treatment, which, in combination with the increasing prevalence of antibiotic resistance among human pathogens, is further complicating treatment of biofilm-related device infections. Therefore, it would be beneficial to coat the surfaces of a device with anti-biofilm plasma coating that inhibits the formation of biofilm on such devices.

Bacteria in biofilm on medical devices behave differently from planktonic bacteria, demonstrating high level of resistance to antibiotic and host immunity. The inherent resistance of biofilms to antibiotics and host immune responses makes eradication of biofilm from medical device difficult. Biofilm infections are treated in clinic by removal or replacement of the infected medical devices, combined with systemic antibiotic therapy. However, biofilm's resistance to antibiotics makes antibiotic treatment less effective. In addition, antibiotic therapy could also exacerbate the antibiotic resistance problems among human pathogens. As a result, much effort has been made to prevent biofilm formation on medical devices.

The development of biofilm could be roughly divided into two steps. Bacterial cells attach and colonize the implanted medical devices in the initial attachment step, following by a maturation step in which bacterial cells would proliferate and accumulate on the device surfaces. Once the biofilm was established, it would form a persistent source for bacterial dissemination and infections. Multiple surface-modified methods have been developed to prevent or decrease biofilm formation on medical devices. The most commonly used materials for surface coating are antibiotics. However, long term usage of antibiotics risks selecting for resistance among pathogens. Aminoglycoside antibiotics can even induce biofilm formation at subinhibitory concentrations. Other materials, which also demonstrated anti-biofilm function when being coated on biomaterial surfaces, include heavy metal ions, furanone, hydrophilic polyethylene glycol (PEG) derivatives and Zwitterionic polymer.

S. epidermidis is one of the most prevalent pathogens involved in biofilm formation on medical devices. S. epidermidis is part of the normal human epithelial bacterial flora, but can cause infection when skin or mucous membrane is injured. S. epidermidis could develop into biofilm and become a persistent source for device associated infections. Antibiotic resistance is wide spread in S. epidermidis and further limits the treatment options.

Another common place for biofilm's formation is the submerging surfaces of water pipelines and reservoirs/containers in a water plant or a residential water system. Multiple bacteria can attach to pipe wall and form biofilm which protect them from disinfection. Pathogens that can form biofilm in water distribution system include Campylobacter jejuni, pathogenic Escherichia coli, Yersinia enterocolitica, Legionella spp., Aeromonas spp., Mycobacterium spp. and Pseudomonas aeruginosa. Disinfectants are typically used to combat biofilm formation. Biofilm formation in water distribution system could cause taste and odor problems and corrosion of pipe materials. Pathogens could be shed into the water and cause infectious diseases.

Low temperature plasma coating deposition is a thin film forming process in a vacuum chamber, where thin films deposit on the surface of substrates under plasma conditions. In a plasma deposition process, monomers are introduced into a plasma reactor and get activated to produce a gaseous complex composed of highly energetic electrons, ions, free radicals and excited monomer molecules, known as the plasma state. In recent years, plasma process has been widely used in the preparation of biomedical materials with unique performance and in the manufacturing of medical devices.

Therefore, there is a need to provide a new and improved device with a modified plasma coating on its contacting/submerging surfaces (which contact with fluids containing bacterial cells), whereas the modified plasma coating having the beneficial properties of inhibiting bacterial attachment and preventing biofilm formation. There is also a need to provide a new and improved implantable medical device with modified plasma coating on its contacting surfaces with the beneficial properties of inhibiting bacterial attachment and preventing biofilm formation and a new and improved methods and process for coating such a device.

### SUMMARY OF INVENTION

In one embodiment of the present inveniton, a process for surface treatment of a fluid-contacting device where a plasma coating is applied to at least one contacting surface of the device. The plasma coating inhibits bacterial attachment to the device and prevents biofilm formation on said device. The plasma coating is generally made up of at least one organo-silicon monomer. In one aspect of the invention the monomer from the silane group and is selected from the following monomers: dimethylsilane, trimethylsilane, vinyltrichlorosilane, tetraethoxysilane, vinyltriethoxysilane, hexamethyldisilazane, tetramethylsilane, vinyldimethylethoxysilane, vinyltrimethoxysilane, tetravinylsilane, vinyltriacetoxysilane, methyltrimethoxysilane, or combinations thereof.

In the process of the present invention the coating is applied to the device at a low temperature by a plasma deposition technique to form a continuous layer on one or more surfaces of the devices. The coating preferably has a thickness from about 1 nm to about 100 nm, more preferably from about 20 nm to about 30 nm.

In another emobidment of the present invention, the coating also includes a gas where the gas is selected from oxygen, O₃, or CO₂. The coating can comprise trimethylsilane and oxygen gas mixed in an approximate ratio of 1 to 4.

In one aspect of the invention, a series of new and improved fluid-contacting devices having at least one contacting/submerging surface with modified plasma coating, whereas said coating has the beneficial properties of inhibiting bacterial attachment and preventing biofilm formation, is described. The inventive fluid-contacting devices can be implantable medical devices, such as catheters, respirators, and artificial cardiovascular implants, prosthetic joints, and contact lenses, whereas one or multiple surfaces of a particular device can contact bacteria containing body fluid of a subject (human or animal). The inventive fluid-contacting devices can also be devices employed in a water system, such as water pipes and water reservoirs/containers, or machineries, where one or multiple surfaces of a particular device can be submerged in the bacteria containing fluid (such as water).

According to one embodiment of the invention, the modified plasma coating with properties of inhibiting bacterial attachment and preventing biofilm formation comprises at least one continuous layer of organo-silicon monomers at a preferable thickness between 1 to 100 nm, with 20 to 30 nm as more preferred. Various organo-silicon monomers can be employed in the invention, including but not limited to a trimethylsilane (TMS) monomer.

According to another embodiment of the invention, the modified plasma coating with properties of inhibiting bacterial attachment and preventing biofilm formation can also comprise at least one continuous layer or organo-silicon monomers and oxygen, or other gases, such as O₃ or CO₂. The modified plasma coating comprises TMS and oxygen, where the ratio of TMS to oxygen is about 1 to 4.

In another aspect of the invention, a new and improved method for reducing and preventing biofilm formation on the contacting/submerging surfaces of a fluid-contacting device is described. The inventive method for reducing and preventing biofilm formation on contacting/submerging surfaces of a fluid-contacting device comprises the step of depositing at least one layer of bacterial-inhibiting plasma coating on surfaces of the device via a low temperature plasma deposition technique, in which the process environment is nearly room temperature.

According to one embodiment of the invention, the inventive method comprises the step of depositing at least one layer of organo-silicon monomer coating on surfaces of said device via low temperature plasma deposition technique, whereas the thickness of said organo-silicon monomer coating preferably ranges from about 1 to 100 nm and more preferably from about 20 to 30 nm, where the organo-silicon monomer is TMS.

According to another embodiment of the invention, the inventive method comprises the step of depositing at least one layer of organo-silicon and oxygen, O₃ or CO₂ plasma coating on surfaces of said device via low temperature plasma deposition technique, where the coating comprises TMS and oxygen with the ratio of about 1 to 4, respectively.

### BRIEF DESCRIPTION OF DRAWINGS

In the accompanying drawings that form a part of the specification and that are to be read in conjunction therewith:

FIG. 1 is a plasma reactor system used for plasma coating deposition of the present invention.

FIG. 2 is a group of charts showing high resolution spectra of Cls for stainless steel (SS) (316L) and titanium (Ti) (Ti6Al4V) substrates before and after TMS coating: (A) C1s of SS without TMS coating, (B) C1s of SS with TMS coating, (C) Cls of Ti without TMS coating, and (D) C1s of Ti with TMS coating.

FIG. 3 are graphical representations of typical surface topography of commercial SS (SS) 316L and Ti alloy Ti6Al4V (Ti) as—received, and TMS plasma coatings on top of them, obtained with Wyko NT 9100 Profiler. Optical images for scanning areas of approximately 125 μm×94 μm: (a1) SS Control, (b1) SS TMS coated, (c1) Ti Control, (d1) Ti TMS coated; and the corresponding surface profiles (a2, b2, c2, d2).

FIG. 4 is a group of charts showing the results of S. epidermidis biofilm formation on TMS coated and uncoated surfaces. A) Crystal violet staining of biofilm formation on four groups of wafers (SS uncoated, SS TMS coated, Ti uncoated and Ti TMS coated) was quantitated by OD595 nm reading of stain solubilized by ethanol. Data was pooled from nine samples (three independent experiments with triplicates) and presented as mean±SEM. **p<0.01. B) Slime production of biofilms on four groups of wafers (SS uncoated, SS TMS coated, Ti uncoated and Ti TMS coated). Data was pooled from nine samples (three independent experiments with triplicates) and presented as mean±SEM. **p<0.01. C) Counts of viable bacterial cells from biofilms on four groups of wafers (SS uncoated, SS TMS coated, Ti uncoated and Ti TMS coated) at different experimental conditions. Data was pooled from nine samples (three independent experiments with triplicates) and presented as mean±SEM. **p<0.01. D) Crystal violet staining of biofilm formation on uncoated and TMS coated silicone wafers. The mean of uncoated control samples was defined as 100%. Data was pooled from six samples (two independent experiments with triplicates) and presented as mean±SEM. **p<0.01.

FIG. 5 is a group of confocal laser scanning microscope studies of biofilm formation. One representative picture was presented from triplicate. A) Biofilm formation on uncoated and TMS coated SS wafers. B) Biofilm formation on uncoated and TMS coated Ti wafers.

FIG. 6 shows pictorial results of scanned electron microscope studies of biofilm formation. One representative picture was presented from triplicate. Biofilm formation on uncoated SS and Ti wafers.

FIG. 7 is a group of charts showing the results of primary attachment assay studies over a 4 hour time course. A) Biofilm formation on uncoated and TMS coated SS wafers. Data was pooled from nine samples (three independent experiments with triplicates) and presented as mean±SEM. **p<0.01. B) Biofilm formation on uncoated and TMS coated Ti wafers. Data was pooled from nine samples (three independent experiments with triplicates) and presented as mean±SEM. *p<0.05, **p<0.01.

FIG. 8 shows pictorial results of confocal laser scanning microscope studies of biofilm attachment assays. One representative picture was presented from triplicate. A) Biofilm formation at 1 hour on uncoated and TMS coated wafers. B) Biofilm formation at 2 hours on uncoated and TMS coated wafers. C) Biofilm formation at 4 hours on uncoated and TMS coated wafers.

FIG. 9 is a group of charts showing biofilm response to antibiotic treatment. Response to antibiotic treatment of a treated sample was defined as the percentage of untreated samples. A) Response of bacterial cells in biofilm on uncoated and TMS coated SS and Ti wafers to 6 μg/ml vacomycin treatment. Data was pooled from four independent experiments with triplicates and presented as mean±SEM. B) Response of bacterial cells in biofilm on uncoated and TMS coated SS and Ti wafers to 6 μg/ml ciprofloxacin treatment. Data was pooled from three independent experiments with triplicates and presented as mean±SEM.

FIG. 10 is a group of charts showing biofilm response to ciproflaxcin treatment. A) Viable cell counts from biofilms on TMS coated and uncoated SS wafers treated with different concentrations of ciproflaxcin. Data was pooled from nine samples (three independent experiments with triplicates) and presented as mean±SEM. B) Viable cell counts from biofilms on TMS coated and uncoated Ti wafers treated with different concentrations of ciproflaxcin. Data was pooled from nine samples (three independent experiments with triplicates) and presented as mean±SEM. The result demonstrated that bacteria on TMS coated surfaces were more susceptible to antibiotic treatment.

FIG. 11 is a diagram of results for biofilm formation in Balb/C female mice by S. epidermidis. Uncoated and TMS coated SS wafers were implanted into female Balb/C mice and inoculated with S. epidermidis to grow biofilms in vivo. The results demonstrates that there were significantly more bacteria recovered from uncoated wafers than from TMS coated wafers (p=0.015), meaning in vivo efficacy of the TMS plasma coating at inhibiting biofilm formation.

FIG. 12 is a chart showing biofilm formation on TMS-coated SS and uncoated SS in tape water. The mean of uncoated control samples was defined as 100%.*p<0.05, **p<0.01

### DETAILED DESCRIPTION OF INVENTION

The invention provides a series of new and improved fluid-contacting devices having at least one contacting/submerging surface with modified plasma coating, whereas said coating has the beneficial properties of inhibiting bacterial attachment and preventing biofilm formation. The inventive devices can be implantable medical devices, such as catheters, respirators, and artificial cardiovascular implants, prosthetic joints, and contact lenses, whereas one or multiple surfaces of a particular device can contact bacteria containing body fluid of a subject (human or animal). Additionally, the inventive devices can also be devices employed in a water system, such as water pipes and water reservoirs/containers, or machineries, whereas one or multiple surfaces of a particular device can be submerged in bacteria containing fluid (such as water). Regardless the applications of the devices, the contacting/submerging surfaces, suitable for modified plasma coating, can be metallic, such as, titanium (Ti), stainless steel (SS), or other metal alloys, and polymeric materials.

Specifically, trimethylsilane (TMS) is used as a monomer to coat the surface of 316L stainless steel (SS) and Grade 5 titanium alloy (Ti), which are widely used in implantable medical devices. As described further herein, the results of biofilm assays demonstrated that this TMS coating markedly decreased the formation of S. epidermidis as wells as other biofilms. In addition, bacterial cells on the TMS coated surfaces are more susceptible to antibiotic treatment than their counterparts in biofilms formed on uncoated surfaces. Therefore, TMS coating results in a surface that is resistant to biofilm development and also more sensitive to antibiotic therapy. Specifically, trimethylsilane (TMS) is used as a monomer to coat the surface of 316L stainless steel (SS) and Grade 5 titanium alloy (Ti), which are widely used in implantable medical devices. The results of biofilm assays demonstrated that this TMS coating markedly decreased the formation of Staphylococcus epidermidis (S. epidermidis) as wells as other biofilms. In addition, bacterial cells on the TMS coated surfaces are more susceptible to antibiotic treatment than their counterparts in biofilms formed on uncoated surfaces. Therefore, TMS coating results in a surface that is resistant to biofilm development and also more sensitive to antibiotic therapy.

According to one embodiment of the invention, the aforesaid modified plasma coating can comprise a continuous layer of organo-silicon monomers with thickness ranging between about 1 to 100 nm. Various organo-silicon monomers can be employed, including but not limited to the following: dimethylsilane, trimethylsilane (TMS), vinyltrichlorosilane, tetraethoxysilane, vinyltriethoxysilane, hexamethyldisilazane, tetramethylsilane, vinyldimethylethoxysilane, vinyltrimethoxysilane, tetravinylsilane, vinyltriacetoxysilane, and methyltrimethoxysilane. According to another embodiment of the invention, the modified plasma coating with properties of inhibiting bacterial attachment and preventing biofilm formation can also comprise at least one continuous layer or organo-silicon monomers and oxygen, O₃ or CO₂. According to an exemplary embodiment, the modified plasma coating comprises TMS and oxygen, whereas the ratio of TMS to oxygen is about 1 to 4.

The surface morphology and chemistry of the TMS-coated device of the present invention (1) preferably has a thickness of the coating layer ranging up to 100 nm and more preferably the coating adhesion is between 20 to 30 nm; (2) does not have a substantial change in surface roughness or morphology caused by the coating; and (3) has substantial surface chemistry change generated by the coating.

The bacterial adherence/attachment and colonization on the TMS-coated and TMS/O₂-coated surfaces of the devices treated with the method of the present invention demonstrates that the organo-silicon plasma or organo-silicon/oxygen plasma coating markedly decreases biofilm formation by inhibiting the bacterial attachment to the coated contacting/submerging surface. Biofilm formation has been compared between the uncoated metallic wafer and the TMS-coated or TMS/O₂-coated metallic wafer, in environments mimicking the devices' host environments (contacting with bodily fluids or tissues, or submerging in bacterial-containing fluids, such as tape water), via several methods, such as crystal violet staining, scanning electronic microscopy (SEM), and confocal laser scanning microscopy (CLSM).

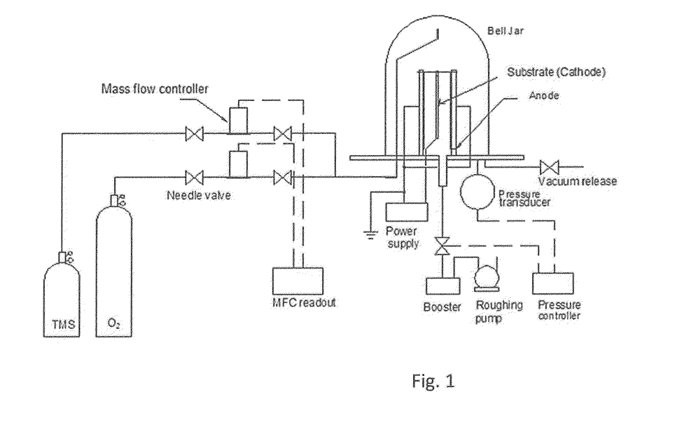

Refer to FIG. 1, which is a schematic diagram of the low temperature plasma deposition setup. Low temperature plasma deposition technique has been developed previously and can be employed to deposit selected organo-silicon monomers or organo-silicon/O₂ onto pre-treated surfaces with some modification. Low temperature plasma coating deposition is a thin film forming process in a vacuum chamber, where thin films deposit on the surface of substrates (cathode) under plasma conditions. In a plasma deposition process, monomers (TMS is specifically shown in FIG. 1) are introduced into a plasma reactor and get activated to produce a gaseous complex composed of highly energetic electrons, ions, free radicals and excited monomer molecules. This is known as the plasma state. In recent years, plasma process has been widely used in the preparation of biomedical materials with unique performance and in the manufacturing of medical devices. For instance, a new nitrogen-rich plasma-deposited biomaterial as an external coating for stent-grafts can promote healing around the implant after endovascular aneurysm repair. Through plasma deposition, many appropriate functional groups, such as amine, hydroxyl, carboxylic acid, useful for the immobilization of bioactive molecules, can be created in the deposited coatings. Open-air or atmospheric plasmas have also been investigated for deposition of functional coatings.

The foregoing is one example of a technique for depositing at least one layer of bacterial-inhibiting plasma coating on surfaces a device via low temperature plasma deposition technique. This layer provides for a reduction and prevention in biofilm formation on the contacting/submerging surfaces of the fluid-contacting device.

According to one embodiment of the invention, the inventive method comprises the step of depositing at least one layer of organo-silicon monomer coating on surfaces of a device via low temperature plasma deposition technique, where the thickness of the organo-silicon monomer coating ranges preferably from about 1 to 100 nm, and more preferably from about 20 to 30 nm. The organo-silicon monomer can be TMS and the coating can comprise TMS and oxygen in a ratio of about 1 to 4, respectively.

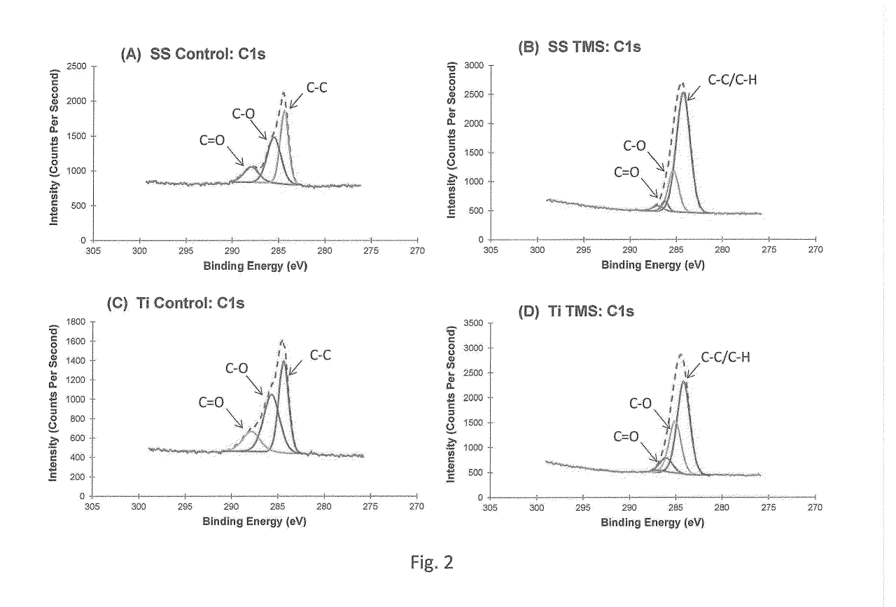

Refer to FIG. 2, which shows the high resolution peaks and the sub-peaks under each peak generated from curve-fitting. Compared to uncoated SS (FIG. 2A), the surface with TMS coating exhibits more C component with a binding energy of 284.5 eV, indicating a high amount of —CH₃ formed on the surface. A similar phenomena noticed on the TMS coated Ti surface as well, indicative of —CH₃ functional groups generated at the surface regardless of the underlying bulk material.

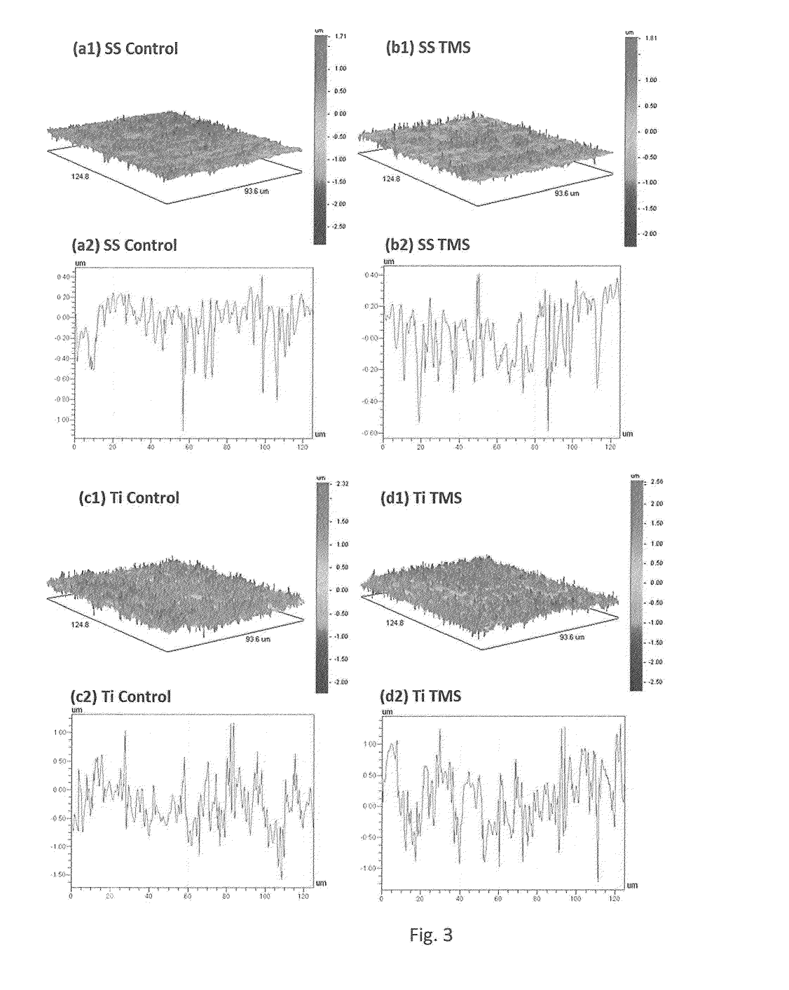

Refer to FIG. 3, which shows typical surface topography of commercial SS (316L) and Ti (Ti6Al4V) as—received, and TMS plasma coatings on top of them. There was no significant difference in surface roughness for both materials, between TMS coated and as-received substrates without plasma coating.

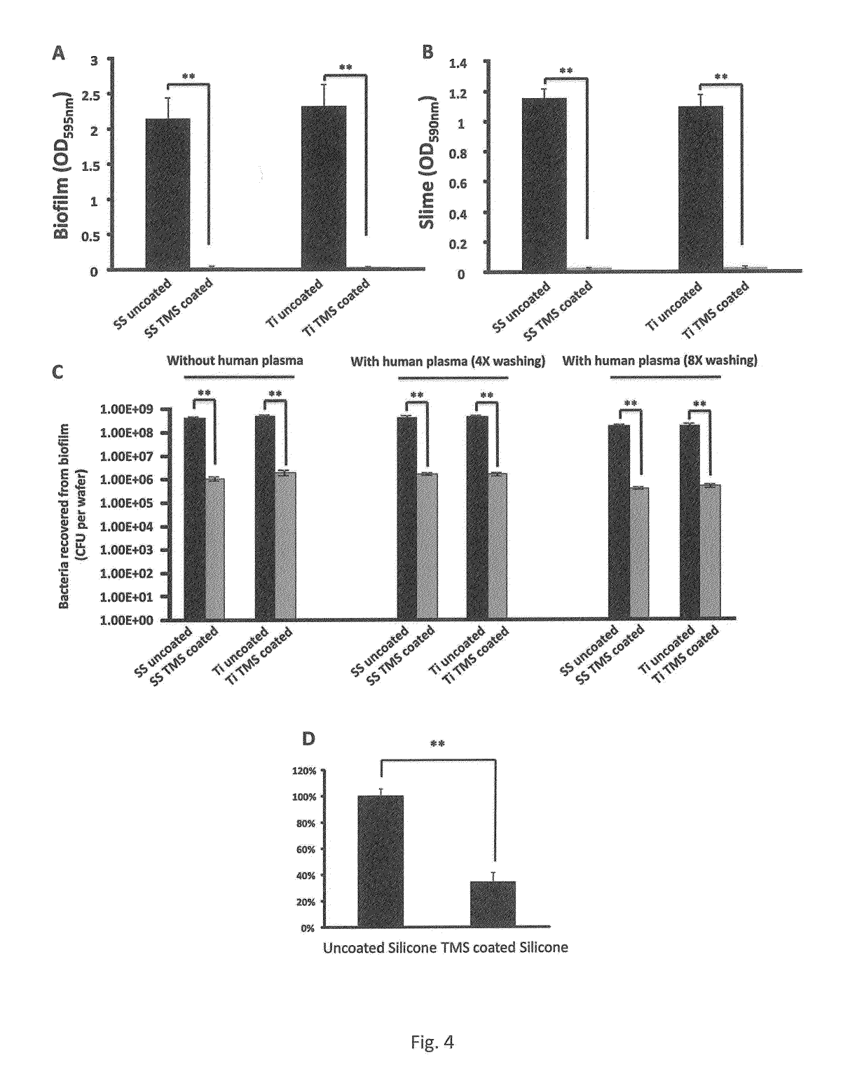

Refer to FIG. 4, which compares S. epidermidis biofilm formations between the TMS coated surfaces and the uncoated surfaces. As shown in FIG. 4A, a crystal violet staining assay has been performed to measure biofilm formation on both stainless steel (SS) and titanium (Ti) wafers, and significant reduction of crystal violet staining has been observed on TMS-coated wafers than control (the uncoated wafers). In order to mimic in vivo host environment, the metal wafers have been pre-coated with human plasma before biofilm assay. In FIG. 4A, More than 98 percent reduction in biofilm staining was observed on both TMS-coated SS (p<0.001) and Ti wafers (p<0.001) (FIG. 4A). The slime production was also significantly reduced on TMS coated surfaces as compared to uncoated controls with 97.8% reduction on SS wafers (p<0.001) and 97.5% reduction on Ti wafers (p<0.001). Similar results were observed (>99.5% reduction of biofilm formation)⁻by counting bacterial cells recovered from biofilms on wafers with or without human plasma pretreatment (FIG. 4C). Biofilm formation was also studied on silicone wafers. Significant reduction of crystal violet staining has been observed on TMS-coated wafers than control (the uncoated wafers) (p<0.001) (FIG. 4D).

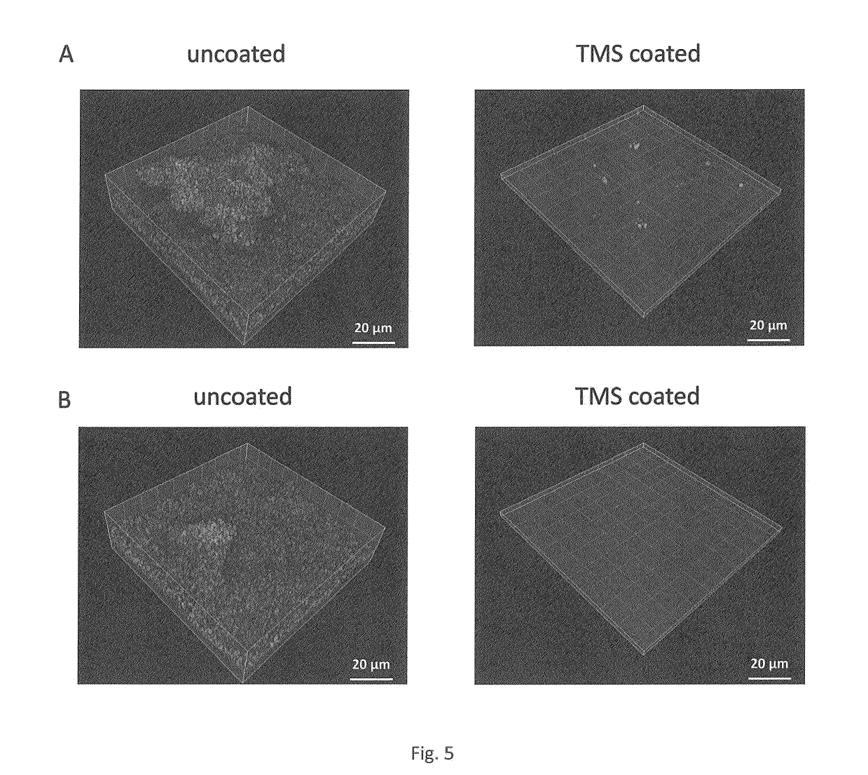

Refer to FIG. 5, which compares the structures of S. epidermidis biofilm and bacterial colonization on metal wafers under CLSM. During the testing, bacterial cells are stained by the Live/Dead Bacterial Viability Kit, whereas live cells with intact cell membranes are stained with SYTO9 and emit a green fluorescence, while dead cells with damaged cell membranes are stained with propidium iodide and emit red fluoresce. As shown in FIG. 5A and 5B, a multilayer mature biofilm are formed on both uncoated SS and Ti wafers. Strikingly, only sporadic cells or cell clusters are observed on TMS coated wafers for both materials. Cell clusters on TMS coated wafers include both living and dead cells, while there are very few dead cells among mature biofilms on uncoated wafers visible by CLSM, illustrating that TMS coating can be detrimental to bacterial cell viability.

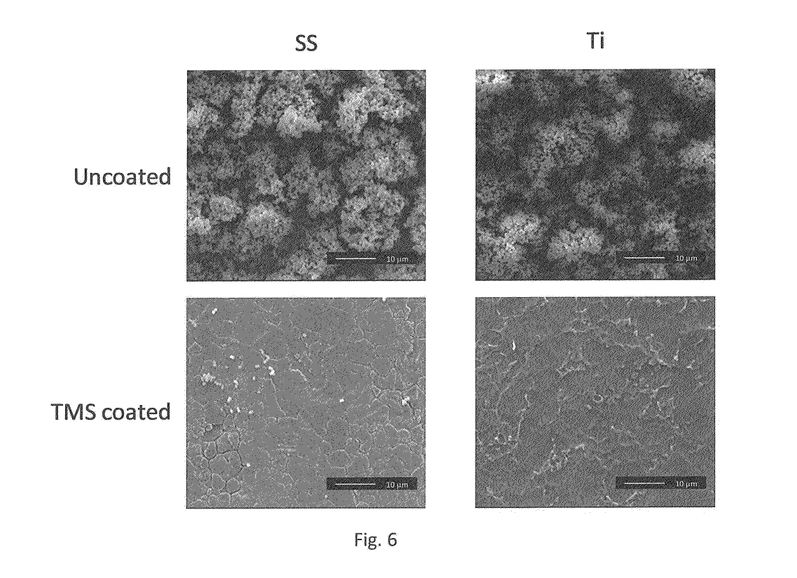

Refer to FIG. 6, which compares the detailed architectures of S. epidermidis biofilm on TMS-coated and uncoated wafers. As shown in FIG. 6, bacterial cells on uncoated SS and Ti wafers have formed conglomerated clusters with numerous bacterial cells in a mesh of matrix. In contrast, SS and Ti wafers with TMS coating are almost clear of bacterial cells, as shown in FIG. 6, in agreement with the CLSM results.

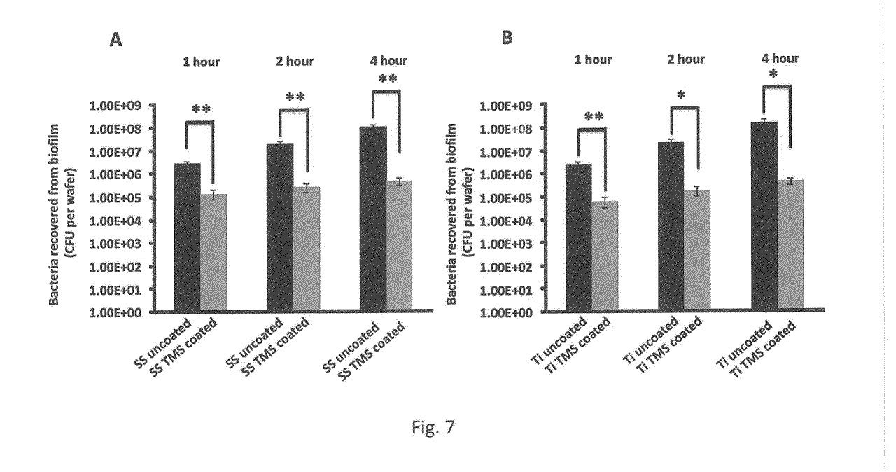

Refer to FIG. 7, which studies the development of S. epidermidis biofilm on the uncoated and TMS coated SS and Ti wafers by time-lapse CLSM. Primary attachment assay over a 4 hour time course has performed to monitor the effect of TMS coating on the initial phase of biofilm formation. At 1 hour time point, bacterial cells adhering to TMS coated wafers was only 4.7% of uncoated SS wafers (1.3±0.6×10⁵ versus 2.8±0.5×10⁶ CFU, p<0.002), and 2.4% of uncoated Ti wafers (6.1±3×10⁴ versus 2.5±0.6×10⁶ CFU, p<0.003). At 2 hour time point, bacterial cells on TMS coated wafers was 1.2% of uncoated SS wafers (2.6±1.1×10⁵ versus 2.1±0.4×10⁷ CFU, p<0.001) and 0.8% of uncoated Ti wafers (1.8±0.8×10⁵ versus 2.2±0.8×10⁷ CFU, p<0.02). At 4 hour time-point, bacterial cells on TMS-coated wafers were less than 1% of uncoated controls. The study indicates that though S. epidermidis can attach and colonize SS and Ti wafers and develop biofilms with complicated structure over the course of 4 hours, attachment and colonization of S. epidermidis have markedly inhibited on TMS-coated surfaces, and the bacteria on TMS coated surfaces fail to progress into later stages of biofilm formation with mature biofilm architecture.

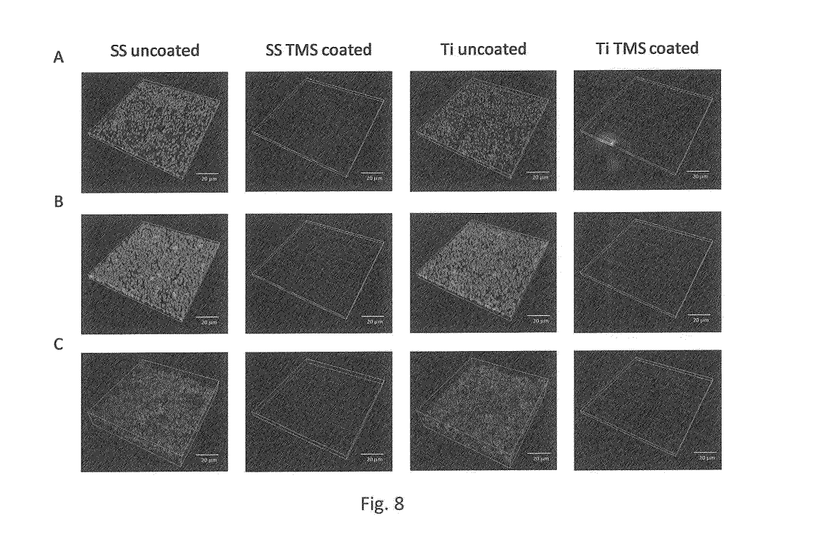

Refer to FIG. 8, which illustrates the CLSM visual comparisons of bacterial colonization (S. epidermidis) on TMS-coated and uncoated metallic wafers. As shown in FIG. 8, on both uncoated SS and Ti wafers, there are scattered areas of bacteria at 1 hour; but after 2 hours, the colonization progressively increases with the formation of some bacterial clusters, though monolayer remains in most areas. After 4 hours, multilayer bacterial clusters with complicated 3-D structures have covered most areas. On the other hand, few individual bacterial colonies have been observed on the TMS-coated SS and Ti wafers at 1-hour, 2-hour, or 4-hours. The CLSM studies further suggest that the biofilm development on TMS-coated surfaces is stalled at the early attachment stage of biofilm formation.

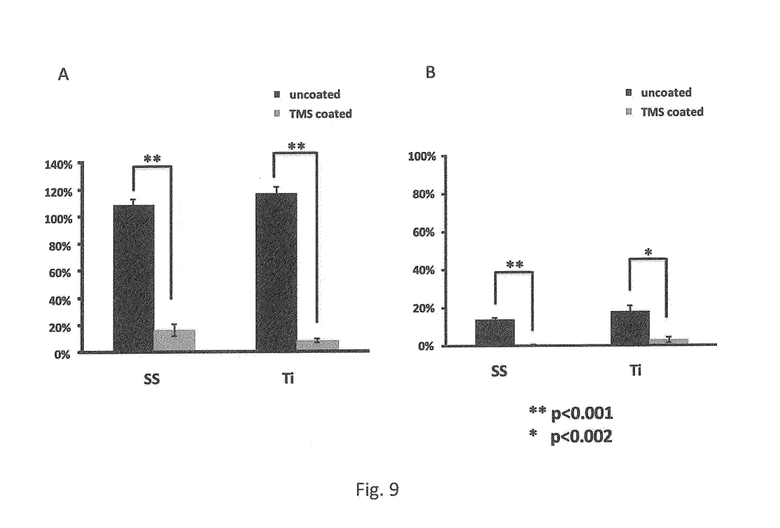

Refer to FIG. 9A, which compares the susceptibilities of the bacteria (S. epidermidis RP62A) on both TMS-coated and uncoated wafers to vacomycin treatment. After the treatment with 6 μg/ml vacomycin, the bacterial count in biofilm on TMS coated wafers are significantly reduced by about 83.8±4.3% (p<0.001) for SS wafer and 91.9±1.6% (p<0.001) for Ti wafer. On the other hand, bacterial cells on the uncoated wafers are resistant to vacomycin treatment. Refer to FIG. 9B, which compares the susceptibilities of the bacteria (S. epidermidis RP62A) in biofilm formed on both TMS-coated and uncoated wafers to ciprofloxacin treatment. As shown in FIG. 9B, ciprofloxacin treatment is able to reduce bacterial count on the uncoated wafers (86±1.2% on SS and 81.8±3.2% on Ti), which suggests that ciprofloxacin is more efficacious at treating S. epidermidis biofilm than vacomycin, in agreement with previous reports. Furthermore, similarly as the vacomycin results, bacterial cells on the TMS coated wafers are markedly more susceptible to ciprofloxacin treatment than cells on the uncoated wafers with 99.4±0.1% reduction on SS and 96.8±1.4% reduction on Ti.

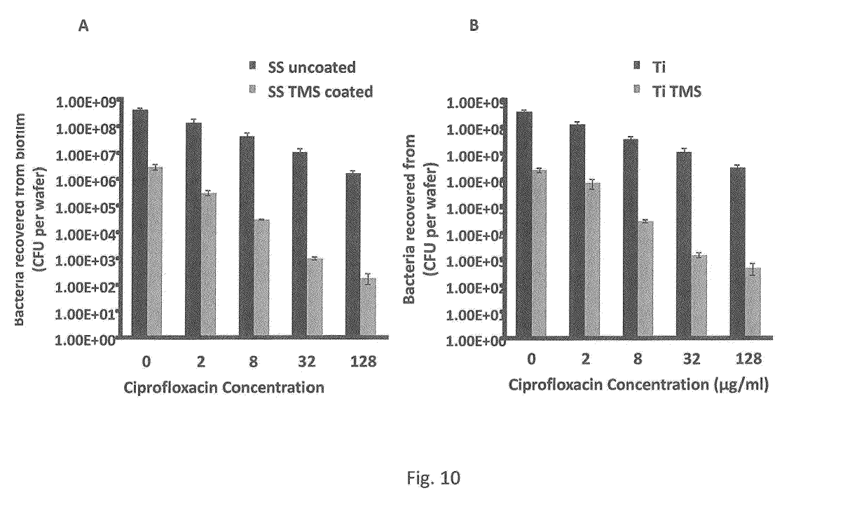

Refer to FIG. 10, which shows detailed analysis of biofilm response to ciproflaxcin treatment at different doses. FIG. 10A shows viable cell counts from biofilms on TMS coated and uncoated SS wafers treated with different concentrations of ciproflaxcin. FIG. 10B shows viable cell counts from biofilms on TMS coated and uncoated Ti wafers treated with different concentrations of ciproflaxcin. Ciprofloxacin treatment reduced bacterial counts on both TMS coated and uncoated wafers in a dose dependent manner (FIG. 10). Ciprofloxacin was able to decrease the number of bacteria recovered from biofilms on uncoated surfaces by more than 99% (2 log10 units) (99.6±0.07% on SS surfaces and 99.3±0.1% on Ti surfaces) at 128 μg/ml, yet to reach 99.9% (3 log10 units) decrease as defined by MBC. On the other hand, bacterial cells on TMS coated wafers were markedly more susceptible to ciprofloxacin treatment (FIG. 10). The number of bacteria on TMS coated surfaces treated with 8 μg/ml ciprofloxacin was less than 0.01% (−4 log10 units) of bacteria on the bare surfaces with neither TMS coating nor ciprofloxacin treatment. Bacteria on TMS coated surfaces treated with 32 μg/ml ciprofloxacin were less than 0.1% (−3 log10 units) of bacteria on TMS coated surfaces without ciprofloxacin treatment, indicating MBCs of ciprofloxacin for biofilms on TMS coated surfaces were less than 32 μg/ml. There were few bacteria recovered from the TMS coated surfaces (177±80 on TMS coated SS surfaces and 444±217 on TMS coated Ti surfaces) when treated with 128 μg/ml ciprofloxacin. The result demonstrated that bacteria on TMS coated surfaces were more susceptible to antibiotic treatment, in agreement with FIG. 9.

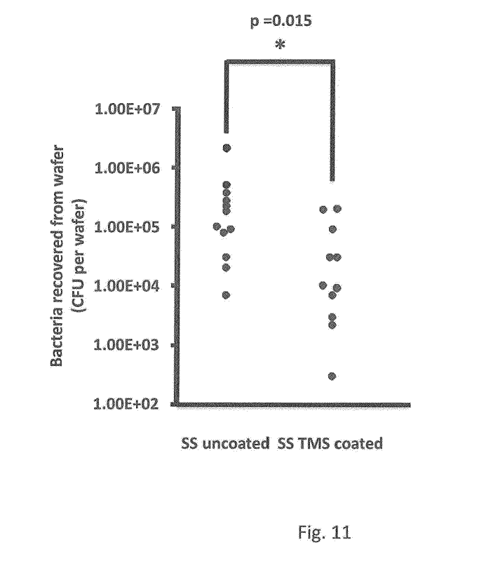

Refer to FIG. 11, showing the results for biofilm formation in Balb/C female mice by S. epidermidis. Uncoated and TMS coated SS wafers were implanted into female Balb/C mice and inoculated with 2×10⁸ CFU S. epidermidis to grow biofilms in vivo. Wafers were harvested after 7 days and bacterial numbers on the wafers were counted and compared. The results demonstrates that there were significantly more bacteria recovered from uncoated wafers than from TMS coated wafers (p=0.015), meaning in vivo efficacy of the TMS plasma coating at inhibiting biofilm formation. The in vivo efficacy of TMS coating technology on inhibiting S. epidermidis biofilm significantly boosts the potential of this technology for clinic application.

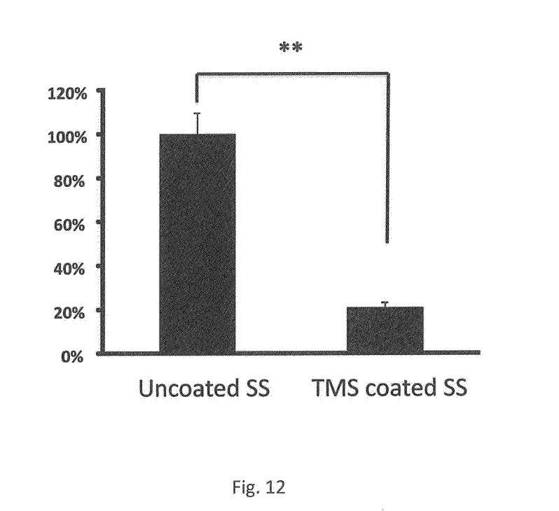

Refer to FIG. 12, which compares the biofilm formations on the TMS-coated and uncoated wafers in tape water. During the testing, 1 liter tap water was stored in a glass beaker for 24 hours to allow the chlorine residue to decay. 3 μl NaOAC (3M) and 0.1 ml PBS were added to the tap water to final concentration of 200 μg/L of carbon and 30 μg/L of phosphorus. Uncoated and TMS coated stainless steel wafers were incubated with tap water for 14 days at room temperature. The wafers were sonicated twice in ultrasonic bath (120V, 50/60 Hz) (Fisher-Scientific, Pittsburgh, Pa.) for 30 seconds and vortexed twice on the highest setting for 30 seconds, respectively. The number of bacterial cells in PBS was quantified using the spread plate technique on R2A medium plates, as directed according to a common testing procedure. As shown in FIG. 12, the biofilm formation is significantly decreased on the TMS-coated surface (p<0.01).

The invention further demonstrates that the organo-silicon plasma coating markedly improves the sensitivities of the coated contacting/submerging surface to antibiotic therapies. The susceptibility of bacterial cells on both TMS coated and uncoated wafers to antibiotic treatment has tested with both vacomycin and ciprofloxacin, and it is found that the bacterial cells on the TMS coated surfaces are significantly more sensitive to antibiotic treatments than those on the uncoated surfaces.

The result suggests that bacteria on the TMS-coated surface have yet to adopt the distinct biofilm phenotype that made them highly resistant to antibiotic treatment. While bacteria in biofilms exhibited great tolerance to ciprofloxacin with MBCs of more than 128 μg/ml, bacteria on the surfaces of TMS coated materials demonstrated significantly increased susceptibility.

In addition, another explanation for the increased susceptibility of bacteria on TMS-coated surfaces is attributable to its structure. While S. epidermidis develops a multilayer biofilm structure, which prevents penetration of antibiotics, or render antibiotics inactivate on uncoated surfaces, S. epidermidis biofilm on TMS-coated surfaces comprises mostly scattered cells with occasional cell clusters with both dead and living cells, which are easily accessible to antibiotics. This result is in agreement with previous study that S. epidermidis cells in monolayer biofilm had a comparatively low tolerance to antibiotics than cells in multilayer biofilm. Reduced slime production also contributed to increased susceptibility of biofilm to antibiotics since substance of exopolysaccharide biofilm matrix has been known to hamper penetrance of antibiotics into biofilm.

In summary, the organo-silicon or organo-silicon/O₂ coated devices, specifically TMS coated devices, are able to inhibit or reduce greatly the bacterial attachment to the surface, and the same time, make the residual bacterial on the surface susceptible to antibiotic treatments. The beneficial properties of organo-silicon coated devices can be employed in various clinical applications.

### EXAMPLES

### Example 1

### TMS-Coated SS and Ti Substrates

SS and Ti substrates. 316L SS and high-strength Ti (Grade 5, also known as Ti-6Al-4V because of the addition of aluminum and vanadium alloying elements) coupons with approximate dimensions 10 mm×10 mm×1 mm were cleaned with a 3% (v/v) Detergent 8 (Alconox, Inc., White Plains, N.Y., USA) solution for 3 hours at 50° C. in an ultrasonic bath. During the cleaning time, samples were removed from the solution every 30 min, rinsed with distilled water, and placed into fresh detergent solution. After cleaning, the metallic coupons were rinsed with acetone and blotted dry with Kimwipes paper.

TMS plasma coating on SS and Ti wafers. The coupons were then attached to an aluminum panel of surface area 15.3 cm×7.6 cm using silver epoxy. Additionally, a silicon wafer was attached to the aluminum panel for coating thickness assessment. The panel was then placed inside an 80 l bell jar-type reactor. This panel was situated between two SS or Ti plates. In this configuration, the central aluminum panel served as the cathode, whereas the two outer SS or Ti panels served as the electrically grounded anodes. This arrangement is typical of a substrate-as-electrode type arrangement in which the sample to be modified serves as the working electrode (cathode). In this scheme, the electrodes were connected to the output of a MDX-1K magnetron drive (Advanced Energy Industries, Inc., Fort Collins, Colo.), which served as a DC power source. The entire reactor setup is indicated in FIG. 1, which shows the electrode assembly in relation to placement inside the vacuum reactor. For silicone rubber material (polydimethylsiloxane, abbreviated as PDMS) widely used for making short and long-dwelling catheters, a 13.56 MHz RF power source (RFX-600, Advanced Energy Industries, Inc., Fort Collins, Colo., USA) in connection to a matching network (ATX-60, Advanced Energy Industries, Inc.) was used for TMS coating deposition. In this arrangement, the aluminum panel with stainless steel wafers to be plasma coated was placed between two active electrodes. The panel was maintained at a floating potential between the two electrodes with one grounded.

Oxygen plasma was used to remove organic contaminants on the SS or Ti surface. The reactor was sealed and evacuated to base pressure (<2 mTorr) using a series mechanical pump and booster pump. Pure oxygen (Praxair Inc., Danbury, Conn.) was then introduced to the reactor at a flow rate of 1 sccm (standard cubic centimeters per minute) using an MKS mass flow controller (MKS Instruments Inc., Andover, Maas.) and an MKS 247C readout to set the flow rate. Pressure was allowed to stabilize at 50 mTorr using an MKS pressure controller. The oxygen was then excited with the DC power supply at 20 W in order to form the plasma. The treatment time was 2 min. Following surface cleaning, the reactor was evacuated to base pressure and TMS (Gelest Inc., Morrisville, Pa.) was introduced to the reactor at 1 sccm. The reactor pressure was allowed to reach 50 mTorr, and the TMS was excited by the DC power supply at 5 W for 15 s.

Surface characterization. Surface characterization was performed using a non-contact optical profilometer, X-ray Photoelectron Spectroscopy (XPS), and contact angle to evaluate the surface topography, chemical composition, and surface wettability respectively.

Surface chemistry analysis. In order to better understand how plasma coating affect the surface chemistry of SS and Ti, all the plasma coated wafers and uncoated controls were analyzed using XPS (X-ray Photoelectron Spectroscopy) at the Material Research Center, Missouri University of Science & Technology, Rolla, Mo. The XPS analysis of a surface provides qualitative and quantitative information on all the elements present (except hydrogen and helium) from the binding energies of the main lines and the peak area, respectively. A Kratos AXIS 165 X-ray Photoelectron Spectrometer (Kratos Analytical Inc., Chestnut Ridge, N.Y.) equipped with a monochromatic A1 Kα X-ray (1486.6 eV) source operating at 150 W was used to characterize the elemental composition and chemical bonding states of the elements present at the substrate surfaces. The take-off angle of the X-ray source was fixed at 90° to the substrate surface for an area of 200 μm×200 μm to be analyzed. Survey spectra, from a 0 to 1200 eV binding energy, were recorded at 160 eV pass energy, a dwell time of 500 ms, and one scan. Whereas the high resolution spectra were taken at 20 eV pass energy, 0.1 eV/step, a dwell time of 500 ms, and a total of twelve scans averaged. The relative atomic concentration of elements detected by XPS was quantified on the basis of the peak area in the survey spectra with sensitivity factors for the Kratos instrument used. High-resolution spectra were charge-compensated by setting the binding energy of the Cls peak to 284.5 eV. Peaks (Cis) were fitted (Gaussian/Lorentzian curves) after background subtraction (Shirley type with CASA XPS (Casa Software Ltd) Version 2.3.15, taking in consideration Scofield sensitivity factors, so as to determine the peak components or chemical states and their elemental concentrations.

The elemental composition of wafers with and without TMS plasma coating is listed in Tables 1 and 2. Those data were calculated from survey scans of substrate surfaces. The major elements on the SS surface were C, O, Fe, Cr, and Si, a trace amount of N, Mo, Ni, and F, which were expected considering the chemical composition of SS (Table 1). The presence of C was mainly due to the contaminant organic species adsorbed onto the metal surface. Oxygen can be attributed to the protective oxide layer that always forms on SS surface. With TMS plasma coating deposited on SS surface, more C and Si were detected.

TABLE 1
Surface elemental composition of SS (316L)
as determined by XPS survey scan

| | Sample ID | | | | | | | | |
|---|---|---|---|---|---|---|---|---|---|
| | C | N | Si | O | Fe | Cr | Mo | Ni | F |
| SS | 44.43 | 1.15 | 2.09 | 35.60 | 10.04 | 4.32 | 0.53 | 0.46 | 1.38 |
| Control | | | | | | | | | |
| SS | 56.18 | 0.00 | 26.57 | 17.25 | 0.00 | 0.00 | 0.00 | 0.00 | 0.00 |
| TMS | | | | | | | | | |

The data in Table 2 indicate that on the surface of Ti control without plasma coating, besides the Ti and Al from the bulk material, a large percent of carbon was present primarily due to organic contaminants on the surface. Oxygen was believed to come from the protective oxide layer that forms on the metal surface quite often. The presence of Zn in a trace amount is due to the contamination happened during the sample handling process. With TMS coating, it is expected to see more carbon and silicon at the surface because of monomer TMS contains three carbon atoms and one Si atom. The oxygen on the TMS coating could be attributed to the oxidation of the coating material after its exposure to the atmosphere, which has been reported to be observed on the surface of many other plasma deposited coatings.

TABLE 2
Surface elemental composition of Ti (Ti6Al4V)
as determined by XPS survey scan

| | Sample ID | | | | | | |
|---|---|---|---|---|---|---|---|
| | C | Zn | Si | O | Ti | Al | Na |
| Ti | 39.19 | 0.37 | 0.00 | 43.20 | 13.38 | 3.86 | 0.00 |
| Control | | | | | | | |
| Ti | 56.38 | 0.00 | 25.79 | 17.62 | 0.00 | 0.00 | 0.21 |
| TMS | | | | | | | |

Surface contact angle. The static water contact angle was determined at room temperature using deionized water. The contact angle formed between a sessile drop and its supporting surface is directly related to the forces at the liquid/solid interface, indicating the hydrophilic or hydrophobic characteristics of the surface. The water droplet size used in the contact measurements was 1 μl, and the measurements were performed and recorded using a computer-aided VCA-2500XE Video Contact Angle System (AST Products Inc., Billerica, Mass.).

Contact angle measurements of uncoated controls and wafers coated with TMS plasma coatings indicated that the TMS coating turned the surface of both 316L SS and Ti (Grade 5) into hydrophobic, reflected by the contact angle increase from about 70° to around 100° (Table 3).

TABLE 3
Contact angle measurements of substrates

Contact Angle

| Material | Uncoated | TMS coated |
|---|---|---|
| SS (316L) | 71° ± 5° | 106° ± 1° |
| Ti (Ti6Al4V) | 66° ± 7° | 99° ± 6° |

The data are presented as means ± standard deviations for n = 5.

Surface profilometry. Surface morphology was measured using a Wyko NT9100 Optical Profilometer (Veeco Instruments, Inc., New York) and Vision (version 4.10) software. This optical profiler performs non-contact, 3-D surface measurements using a vertical scanning interferometry (VSI) mode for a wide variety of topologies. The samples were mounted in horizontal position for measurements. The measurements were made over an approximately 125 μm×94 μm area. Each sample was scanned in 5 locations. The scan resolution is 500 nm laterally and 0.5 nm vertically. Before calculating the topography parameters, raw data were processed with a tilt correction. From the corrected and smoothed data the surface roughness parameters Ra (arithmetic average of the absolute values of vertical deviations from a mean plane), Rq (the root mean square roughness) were derived. The Ra and Rq will be used to characterize the surface roughness before and after TMS plasma coating. They are expressed in units of height. It is understood that surface roughness of biomaterials will affect cell attachment and proliferation.

The optical images of the surface topography of SS (316L) and Ti (Ti6Al4V) substrates before and after TMS plasma coating were presented in FIG. 3, and the corresponding surface roughness data calculated by the optical profilometer are summarized in Table 4. There was no significant difference in surface roughness for both materials, characterized by the average roughness (Ra) and the root mean square roughness (Rq) parameters (Table 4), between TMS coated and as-received substrates without plasma coating. This observation was supported by the statistical analysis result p>0.05 using one way ANOVA. In other words, the surface roughness was largely determined by the bare SS and Ti substrates, and a thin layer of TMS plasma coating in the thickness of 20-30 nm could not substantially change the underlying substrate roughness at a level of 200-300 nm, even though the standard deviation of surface roughness for TMS coated SS or Ti substrates appeared to be smaller than their uncoated counterparts. It was also noted that the Ti substrates had rougher surface than SS as-received.

TABLE 4
Surface roughness analysis of SS and Ti without and with TMS coating

Surface roughness (nm)

| Sample ID | Ra | Rq |
|---|---|---|
| SS Control | 229.14 ± 56.56 | 312.44 ± 79.38 |
| SS TMS | 208.44 ± 20.57 | 292.14 ± 32.96 |
| Ti Control | 336.22 ± 43.85 | 423.73 ± 52.72 |
| Ti TMS | 340.68 ± 25.06 | 431.03 ± 28.63 |

The data are presented as means ± standard deviations for n = 5.

### Example 2

### TMS/O₂-Coated SS and Ti Substrates

SS and Ti wafers that had went through cleaning procedure were then mounted sample holder made from aluminum strip and stainless steel rod using small clips. Additionally, a silicon wafer was mounted to the sample holder for coating thickness assessment. The sample holder was then placed inside an 80 l bell jar-type reactor. This holder was situated between two titanium plates. In this configuration, the wafers and the sample holder served as the cathode, whereas the two outer titanium panels served as the electrically grounded anodes. This arrangement is typical of a substrate-as-electrode type arrangement in which the sample to be modified serves as the working electrode (cathode). In this scheme, the electrodes were connected to the output of a MDX-1K magnetron drive (Advanced Energy Industries, Inc., Fort Collins, Colo., USA), which served as a DC power source. The entire reactor setup is indicated in FIG. 1, which shows the electrode assembly in relation to placement inside the vacuum reactor.

Oxygen plasma was used to remove organic contaminants on the stainless steel surface. The reactor was sealed and evacuated to base pressure (<2 mTorr) using a series mechanical pump and booster pump. Pure oxygen (Praxair Inc., Danbury, Conn., USA) was then introduced to the reactor at a flow rate of 1 sccm (standard cubic centimeters per minute) using an MKS mass flow controller (MKS Instruments Inc., Andover, Mass., USA) and an MKS 247C readout to set the flow rate. Pressure was allowed to stabilize at 50 mTorr using an MKS pressure controller. The oxygen was then excited with the DC power supply at 20 W in order to form the plasma. The treatment time was 2 mM. Following surface cleaning, the reactor was evacuated to base pressure and TMS (Gelest Inc., Morrisville, Pa., USA) and oxygen were simultaneously introduced to the reactor at a mass flow ratio of 1:4 (TMS flow rate 1 sccm, and oxygen flow rate 4 sccm). The reactor pressure was allowed to reach 50 mTorr, and the TMS plus oxygen were excited by the DC power supply at 5 W to form coating on the substrates for 90 s.

### Example 3

### S. epidermidis Attachment and Colonization on TMS-Coated SS and Ti Wafers

The S. epidermidis strain ATCC35984/RP62A was isolated from a patient with device-associated sepsis. This strain was demonstrated to be a high biofilm producer. RP62A was kindly provided by Network on Antimicrobial Resistance in Staphylococcus aureus program (NARSA), which is supported under NIAID, NIH Contract No. HHSN272200700055C.

Biofilm Formation Assay.

Biofilm formation was first measured by crystal violet (CV) staining. Four groups of 1×1 cm wafers (SS uncoated, SS TMS coated, Ti uncoated and Ti TMS coated) were used in the experiments. Wafers were sterilized with ultraviolet lamps at a wavelength of 253.7 nm for 20 minutes on each side and then coated with 20% (v/v) human plasma in 50 mM carbonate buffer (pH 9.5) overnight. The content of one capsule for Carbonate-Bicarbonate Buffer (Sigma-Aldrich, St. Louis, Mo.) was dissolved in 80 ml distilled and deionized water and mixed with 20 ml human plasma to generate 20% human plasma in 50 mM carbonate buffer (pH9.5). The human plasma was purchased from Innovative Research (Innovative Research, Inc, Novi, MI), with sodium citrate as anticoagulant.

After human plasma adsorption, wafers were placed into wells of 24-well flat-bottomed sterile microtiter plates (TPP Techno Plastic Products AG, Trasadingen, Switzerland). An overnight culture of S. epidermidis was diluted at 1:200 in Todd-Hewitt broth containing 0.2% yeast extract (THY) medium with 0.5% glucose. Aliquots (1 ml) of the diluted bacterial suspensions were inoculated into the wells containing wafers pre-coated with human plasma and incubated for 48 hours at 37° C., with medium changed every 12 hours. Triplicate wafers of each group (SS uncoated SS, SS TMS coated SS, Ti uncoated and Ti TMS coated) were used.

The wafers were washed four times with Phosphate-Buffered Saline (PBS) to remove non-adherent bacterial cells. Biofilms on wafers were dried at 37° C. for 1 hour, and stained at room temperature with 2.3% (w/v) crystal violet (CV) (Sigma-Aldrich, St Louis, Mo.) for 30 minutes. The wafers were rinsed four times with PBS to remove excess stain. Biofilm formation was quantified by solubilization of the CV stain in 100% ethanol The concentration of CV was determined by measuring OD595 nm with a microplate reader (Molecular Devices, Sunnyvale, Calif.). The experiment was performed three times to obtain the means and standard errors of means.

Biofilms were formed on the four groups of wafers in triplicate as described above with or without human plasma pretreatment. The wafers were washed four times with PBS to remove non-adherent bacterial cells. The wafers were put into tubes with PBS. The biofilms on wafers were detached and disaggregated with ultrasonic bath treatment. The wafers were sonicated 6 times in ultrasonic bath (120V, 50/60 Hz) (Fisher-Scientific, Pittsburgh, Pa.) for 30 seconds and vortexed on the highest setting for 30 seconds after each sonication. The number of bacterial cells in PBS was quantified using the spread plate technique. The experiment was performed three times to obtain the means and standard errors of means.

Biofilm was formed on SS and Ti wafers as described above and slime was measured as reported before. Biofilms were formed on four groups of wafers (SS uncoated, SS TMS coated, Ti uncoated and Ti TMS coated) as described above and slime was measured. To exclude the possibility that TMS coating could affect the binding of toluidine on metal wafers, wafers were also incubated with culture medium without S. epidermidis inoculum as blank control. Triplicate wafers of each group were used in each experiment. Biofilm samples on the wafers were fixed by Carnoy's solution (glacial acetic acid, chloroform and absolute alcohol (1:3:6, v/v)) for 30 minutes, and stained by 0.1% toluidine solution (Sigma-Aldrich, St Louis, Mo.) for 30 minutes. The wafers were subsequently incubated in 0.2 M NaOH solution, heated in a water bath at 85° C. for 1 hour and OD590 nm was measured. The mean of OD590 nm value of blank control wafers in each group was used as blank to calibrate the value of slime formation in each group. The experiment was performed three times to obtain the means and standard errors of means.

Biofilm attachment assay. The four groups of wafers in triplicate were sterilized and coated with human plasma as described above. Overnight cultures of S. epidermidis were diluted in fresh THY with 0.5% glucose to an OD600 nm value of 0.02 and grown at 37° C. to an OD600 nm value of 0.5. Aliquots (1 ml) were then pipetted into sterile wells containing wafers and incubated at 37° C. for 1 hour, 2 hours and 4 hours, respectively. Culture supernatants were gently removed with a pipette. The wafers were washed four times with PBS and then put into tubes with PBS. The wafers were sonicated twice in ultrasonic bath (120V, 50/60 Hz) (Fisher-Scientific, Pittsburgh, Pa.) for 30 seconds and vortexed twice on the highest setting for 30 seconds, respectively. The number of bacterial cells in PBS was quantified using the spread plate technique. The experiment was performed three times to obtain the means and standard errors of means.

Fluorescent staining of adherent bacteria. SS and Ti wafers (1×1 cm) were sterilized, coated with human plasma, and placed into the wells of 24-well microplates. Overnight culture of S. epidermidis was diluted 1:200 into fresh THY medium with 0.5% glucose. Aliquots (1 ml) of the cell suspensions were seeded into each well containing wafers and incubated at 37° C. to form biofilm as described above. The wafers were gently washed three times with PBS to remove non-adherent bacterial cells. Adherent bacterial cells were stained using the LIVE/DEAD BacLight viability kit (Invitrogen, Carlsbad, Calif.) according to the manufacturer's instructions, followed by three PBS washes to remove nonspecific stain. Fluorescence-adherent bacteria were visualized by confocal laser scanning microscope Zeiss LSM 510 (Carl Zeiss Microlmaging GmbH, Jena, Germany). Images were acquired from random locations within the biofilm formed on SS and Ti wafers. 3D structural reconstruction of confocal laser scanning microscope (CLSM) image stacks was performed using Imaris 4.0 (Bitplane AG, Zurich,. Switzerland).

Scanning electron microscopy. SS and Ti wafers (1×1 cm) were sterilized by irradiating with UV for 15 minutes, coated with human plasma, and placed into the wells of 24-well microplates. Overnight culture of S. epidermidis was diluted 1:200 into fresh THY medium with 0.5% glucose. Aliquots (1 ml) of the cell suspensions were seeded into each well containing wafers and incubated at 37° C. to form biofilm as described above. The wafers were gently washed three times with PBS to remove non-adherent bacteria and fixed with 2.5% glutaraldehyde in 0.15 M sodium cacodylate buffer (pH 7.4) for 2 h at 4° C. The surfaces were washed twice with PBS for 1 hour and subsequently fixed with 0.1% osmium tetraoxide for 1 hour. The bacteria were then dehydrated by replacing the buffer with increasing concentrations of ethanol (20%, 50%, 70%, 90%, 95%, 100%, 100% and 100%) for 15 minutes each. After critical-point drying and coating by gold sputter, samples were examined using a scanning electron microscope.

Susceptibility of bacterial cells in biofilm to antibiotics was studied with a protocol established previously with modification. SS and Ti wafers (1×1 cm) were sterilized, coated with human plasma, and placed into the wells of 24-well microplates. Overnight culture of S. epidermidis was diluted 1:200 into fresh THY medium with 0.5% glucose. Aliquots (1 ml) of the cell suspensions were seeded into each well containing wafers and incubated at 37° C. for 16 hours. The wafers were gently washed three times with PBS to remove non-adherent bacterial cells. Then fresh Mueller Hinton broth (MHB) with and without 6 μg/ml vancomycin or ciprofloxacin was added into the wells containing wafers and cultured at 37° C. for 8 hours. The wafers were washed four times with PBS and then put into tubes with PBS. The biofilms on wafers were detached and disaggregated with ultrasonic bath treatment. The number of bacterial cells was quantified using the spread plate technique. Response to antibiotic treatment of a treated sample was defined as the percentage of untreated samples calculated by CFU numbers. Triplicate of wafers were used in each experiments and four independent experiments were performed for vacomycin and three independent experiments were performed for ciprofloxacin.

Antibiotic susceptibility assay of S. epidermidis cells attached on wafers with different dose of antibiotics. Biofilm formation on the four groups of wafers in triplicate was performed as described in biofilm formation assay section. The wafers with biofilms were gently washed four times with PBS to remove non-adherent bacterial cells. Then fresh Mueller Hinton broth (MHB) with 0, 2, 8, 32, and 128 μg/ml ciprofloxacin (Sigma-Aldrich, St Louis, Mo.) was added into the wells containing wafers and cultured at 37° C. for 48 hours, with MHB medium with corresponding concentration of ciprofloxacin changed every 12 hours. The wafers were washed four times with PBS and bacteria numbers on the wafers were counted.

Mouse infection model. Overnight cultures of S. epidermidis RP62A were diluted 1:100 into fresh THY medium and grown at 37° C. to OD600 nm 0.5. Fifty ml culture aliquots were sedimented by centrifugation, washed in PBS, and suspend in 2 ml Pluronic® F-127 solution. Balb/C female mice were anesthetized with ketamine/xylazine. Their flanks were shaved, and the skin was cleansed with ethanol. A 0.5 cm-1.0 cm incision was made. The uncoated or TMS-coated SS wafers were implanted into the subcutaneous tunnel and placed at a distance of about 2 cm from the incision. One hundred μl suspensions of S. epidermidis (about 2-3×10⁸ CFU) were inoculated onto the wafers. The incision was closed with surgical sutures, with the skin disinfected. Animals were euthanized at day 7 after infections. Implanted SS wafers were harvested, rinsed with sterile PBS three times. The numbers of bacterial cells on the wafers were counted.

Biofilm formation assay on silicone wafer. 1×1 cm silicone wafers (uncoated, TMS coated) were used in the experiments. Biofilm formation assay were performed following the sample protocol for SS and Ti wafers measured by crystal violet staining.

Unless otherwise defined, all technical and scientific terms used herein have the same meaning as commonly understood by one of ordinary skill in the art to which this invention belongs. All publications, patent application, patents, and other references mentioned herein are incorporated by reference in their entirety. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

While the invention has been described in connection with specific embodiments thereof, it will be understood that the inventive device is capable of further modifications. This patent application is intended to cover any variations, uses, or adaptations of the invention following, in general, the principles of the invention and including such departures from the present disclosure as come within known or customary practice within the art to which the invention pertains and as may be applied to the essential features herein before set forth.

What claimed is

1. A process for surface treatment of a fluid-contacting device comprising the step of:
applying a plasma coating to at least one contacting surface of said device, wherein said plasma coating inhibits bacterial attachment to said device.

2. The process of claim 1 wherein said plasma coating prevents biofilm formation on said device.

3. The process of claim 1 wherein said plasma coating is comprised of at least one organo-silicon monomer.

4. The process of claim 1 wherein said plasma coating is applied at a low temperature by a plasma deposition technique in vacuum or at atmospperic pressure to form a continuous layer on said at least one surfce of said device.

5. The process of claim 4 wherein said layer having a thickness from about 1 nm to about 100 nm.

6. The process of claim 5 wherein said layer having a thickness from about 20 nm to about 30 nm.

7. The process of cliam 1 wherein said at least one monomer is from the silane group and is seleceted from dimethylsilane, trimethylsilane, vinyltrichlorosilane, tetraethoxysilane, vinyltriethoxysilane, hexamethyldisilazane, tetramethylsilane, vinyldimethylethoxysilane, vinyltrimethoxysilane, tetravinylsilane, vinyltriacetoxysilane, methyltrimethoxysilane, or combinations thereof.

8. The process of claim 2 wherien said coating further comprises a gas, wherein said gas is selected from oxygen, O₃, or CO₂.

9. The process of claim 1 wherein said coating comprises said trimethylsilane and said oxygen gas mixed in an approximate ratio of 1 to 4.

10. The process of claim 1 wherein said coating is uniformly applied to substantially all of said at least one contacting surface of said device.

11. The process of claim 1 wherein said device is selected from implantable medical devices, catheters, respirators, artificial cardiovascular implants, prosthetic joints, contact lenses, water pipes, water reservoirs, water containers, or water machineries.

12. A method for reducing or preventing bioffim formation on at least one surface of a fluid-contacting device comprising the step of:
applying at least one layer of a bacterial-inhibiting plasma coating on said at least one surface of said device using a low temperature plasma deposition technique in vacuum or at atmospperic pressure.

13. The method of claim 12 wherein said plasma coating comprises of at least one organo-silicon monomer.

14. The method of claim 13 wherein said at least one monomer is selected from dimethylsilane, trimethylsilane, vinyltrichlorosilane, tetraethoxysilane, vinyltriethoxysilane, hexamethyldisilazane, tetramethylsilane, vinyldimethylethoxysilane, vinyl-trimethoxysilane, tetravinylsilane, vinyltriacetoxysilane, or methyltrimethoxysilane.

15. The method of claim 13 wherein said plasma coating having a thickness from about 20 nm to about 30 nm.

16. The method of claim 13 wherein said plasma coating further comprises oxygen gas and wherein said monomer is trimeythlsilane, and further wherein said trimethylsilane and said oxygen gas are mixed in an approximate ratio of 1 to 4.

17. The method of claim 12 wherein said device is selected from implantable medical devices, catheters, respirators, artificial cardiovascular implants, prosthetic joints, contact lenses, water pipes, water reservoirs, water containers, or water machineries.

18. A fluid-contacting device having an organo-silicon plasma coating on at least one surface of said device to prevent biofilm formation and inhibit bacterial attachment to said device.

19. The device of claim 18 wherein said plasma coating comprises trimeythlsilane and oxygen gas mixed in an approximate ratio of 1 to 4.

20. The device of claim 19 wherein said device is selected from implantable medical devices, catheters, respirators, artificial cardiovascular implants, prosthetic joints, contact lenses, water pipes, water reservoirs, water containers, or water machineries.
